(19) United States
(12) Patent Application Publication
(10) Pub. No.: US 2024/0360312 A1
(43) Pub. Date: Oct. 31, 2024

(54) PURIFICATION METHODS FOR MODIFIED ROSIN COMPOSITIONS

(71) Applicant: INGEVITY SOUTH CAROLINA, LLC, North Charleston, SC (US)

(72) Inventors: Bing Wang, North Charleston, SC (US); Mitra Shiram Ganewatta, North Charleston, SC (US); Thomas M. Sisson, North Charleston, SC (US)

(21) Appl. No.: 18/565,012

(22) PCT Filed: Jun. 9, 2022
(86) PCT No.: PCT/US2022/032773

§ 371 Date: Nov. 28, 2023

Related U.S. Application Data
(60) Provisional application No. 63/208,764, filed on Jun. 9, 2021.

(51) Int. Cl. C08L 93/04; C09F 1/02; C09F 1/04

(52) U.S. Cl. CPC C08L 93/04; C09F 1/02; C09F 1/04

(57) ABSTRACT

Presently described are purification methods for modified rosin compositions, purified compositions, and articles thereof. The methods described herein use a solvent. The solvent can include at least one of a hydrocarbon solvent, a bio-based solvent, or a combination thereof. The purified modified rosin compositions have higher amounts of the modified rosin as compared with modified rosin compositions that have not been purified.

### CROSS REFERENCE TO RELATED APPLICATIONS

This application claims the benefit of U.S. Application No. 63/208,764 filed on Jun. 9, 2021, which is incorporated herein by reference in its entirety.

### BACKGROUND

### 1. Field of the Discovery.

The present disclosure relates to methods to improved methods for the purification of a modified rosin composition. The modified rosin compositions comprise a modified rosin comprising an adduct from a cycloaddition reaction such as Diels Alder or Ene reaction of a rosin acid and impurities, such as for example, a rosin acid that did not undergo the cycloaddition or cationic reaction. In certain aspects, the modified rosin compositions are derived from tall oil rosins, gum rosins or wood rosins. The isolated modified rosin precipitates obtained from the disclosed methods have improved purities, high softening points, and high acid numbers than conventional rosin or modified rosin.

### 2. Background Information.

Rosin, a bio-renewable raw material, is commercially available, and can be obtained from pine trees by distillation of oleorosin (gum rosin being the residue of distillation), by extraction of pine stumps (wood rosin) or by fractionation of tall oil (tall oil rosin). Rosin contains a mixture of rosin acid isomers and small amounts of fatty acids, and other unsaponifiable compounds.

Tall oil, a type of rosin (originating from the Swedish word “tallolja” (“pine oil”)) is obtained as a by-product of Kraft pulping in the paper making process. A product of the Kraft process, black liquor soap skimming, is converted to crude tall oil (CTO), can be further purified by distillation to provide tall oil heads, tall oil fatty acids (TOFA), distilled tall oil (DTO), tall oil rosin (TOR), and tall oil pitch. These products have long been used in traditional fields such as inks, adhesives, oil fields, mining, paper sizing, and detergents.

One of the most utilized reactions for the preparation of modified rosins is the Diels-Alder reaction on conjugated rosin species, such as Palustric, Abictic acid and Neoabietic acid, which are commonly called PAN acids. These PAN acids are present in rosin about 30-60% by weight depending on the region, season, and tree species. Alkenes with electron withdrawing groups such as fumaric acid, maleic anhydride, itaconic acid or anhydride can be used to react with rosin acids via the Diels-Alder reaction or other types of carbon-carbon bond formation reactions such as an Ene-reaction or a cationic reaction. For example, maleopimaric acid can be synthesized this way by the thermal reaction between rosin with maleic anhydride.

The degree of adduct formation depends on % PAN acids that are present in the particular rosin, which varies depending on the source of the rosin. In general, when a rosin is modified to form a reaction adduct, some amount of rosin that cannot undergo such reactions remains and contaminates the product as monofunctional acids such as dehydroabietic acid. For example, rosin can be modified by thermal or catalytic reaction with butenedioic acid (see Scheme 1).

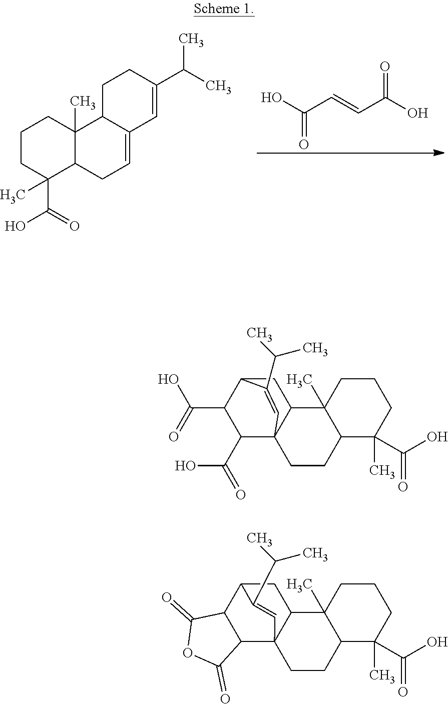

When a rosin undergoes reaction with butenedioic acid, a mixture of unreacted rosin (UR), maleated rosin (MR) and fumarated rosin (FR) is obtained. Maleated rosin in this case is generated as a side-product due to dehydration and anhydride formation. When the rosin substrate is derived from distilled tall oil, the reaction product can be 1-10% maleated rosin, 20-55% fumarated rosin, and 30-60% unreacted rosin. It follows that there is a substantial amount of unreacted starting material that can remain in the reaction mixture and contaminate the modified rosin.

There are few published patents that disclose methods for modified rosin purification. CN101591239A disclose a method of partially converting fumarated rosin to its salt in an organic solvent such as ethanol, methanol, or acetone with strong base, filtering the precipitated salt, recrystallizing the crude salt in an organic solvent, isolating the recrystallized salt, and then converting the salt back to the acid using aqueous dilute acid. Although the method discloses that the purity of the fumarated rosin can be as high as 95%, the disclosed methods are quite cumbersome and not commercially practical.

U.S. Pat. No. 2,889,362 describes a method using different organic solvents, washing with water and repeated precipitation to get final product in very low yield that is also cumbersome and not commercially practical.

U.S. Pat. No. 3,562,243 discloses a method that includes dissolving the crude rosin adduct in a polar liquid solvent to provide a first solution. To the first solution is added a non-polar organic liquid solvent to provide a mixture. This mixture is vigorously agitated. Owing to the fact that the solvents are substantially immiscible in each other, two phases will form, an upper or non-polar phase, and a lower or polar phase. The lower or polar phase contains the rosin adducts and the rosin adducts are recovered.

While attempting to verify and further optimize the biphasic method based on U.S. Pat. No. 3,562,243, the inventors found it still difficult to scale-up as the process was sensitive to solvent ratio (polar: non-polar) and temperature fluctuation, which became an obstacle for making this process a viable commercial process. In addition, the need of a multi-solvent recovery system further increased the cost and difficulty of this process.

While conventional methods can be used for the separation of modified rosins from unreacted rosin, they suffer from several key disadvantages, including lackluster yields and being overly cumbersome and therefore not amenable to commercial scale-up. As such, there is a need for improved methods for the separation of modified rosins from unreacted rosin that are amenable to scale-up procedures and therefore suitable for industrial applications.

### SUMMARY

Presently described are methods purifying modified rosin compositions. The methods described herein utilize a unique and simple solvent precipitation process that surprisingly and unexpectedly significantly separates reacted rosin from unreacted rosin. The resulting purified modified rosin precipitate has much improved characteristics (e.g., enhanced percentage of modified rosin, color, softening point, and acid number) as compared with the modified rosin composition that has not been purified using the disclosed methods.

In any of the aspects or embodiments described herein, a method is disclosed for the purification of a modified rosin composition comprising the steps of:
a. admixing a modified rosin composition and at least one solvent to form a mixture;
b. agitating the mixture; and
c. isolating a purified modified rosin composition,

wherein the modified rosin composition comprises a modified rosin adduct from a cycloaddition or cationic reaction of a rosin acid.

In any of the aspects or embodiments described herein, a method is disclosed for the purification of a modified rosin composition comprising the steps of:

adding a modified rosin composition to a continuous heated extraction apparatus; and

extracting the modified rosin composition with at least one solvent in the continuous heated extraction apparatus;

wherein the modified rosin composition comprises a modified rosin comprising an adduct from a cycloaddition or cationic reaction.

In any of the aspects or embodiments described herein, a purified modified rosin composition is disclosed that is prepared by the disclosed methods, comprising the modified rosin adduct from a cycloaddition or cationic reaction and the rosin acid(s) that did not undergo the cycloaddition or cationic reaction, wherein the modified rosin adduct is present in an amount 70% or greater as determined by gel permeation chromatography.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### DETAILED DESCRIPTION

The present disclosure will now be described more fully hereinafter, but not all embodiments of the disclosure are shown. While the disclosure has been described with reference to exemplary embodiments, it will be understood by those skilled in the art that various changes can be made and equivalents can be substituted for elements thereof without departing from the scope of the disclosure. In addition, many modifications can be made to adapt a particular structure or material to the teachings of the disclosure without departing from the essential scope thereof.

Where a range of values is provided, it is understood that each intervening value between the upper and lower limit of that range and any other stated or intervening value in that stated range is encompassed within the invention. The upper and lower limits of these smaller ranges can independently be included in the smaller ranges is also encompassed within the invention, subject to any specifically excluded limit in the stated range. Where the stated range includes one or both of the limits, ranges excluding either both of those included limits are also included in the present disclosure.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of.” “only one of,” or “exactly one of.”

In the claims, as well as in the specification above, all transitional phrases such as “comprising.” “including.” “carrying.” “having.” “containing.” “involving.” “holding.” “composed of.” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

### Exemplary Aspects and Embodiments

Surprisingly and unexpectedly, the inventors discovered a modified rosin composition can be purified using simple methods of mixing the modified rosin composition with at least one solvent, agitating the mixture, and isolating the purified modified rosin precipitate. Alternatively, the modified rosin composition can be placed in a continuous heated extraction apparatus and extracted with at least one solvent that is present in the continuous heated extraction apparatus. When the rosin is modified such as in a cycloaddition reaction or cationic reaction, some amount of rosin does not undergo reaction. This unreacted material (e.g., monofunctional acids) can contaminate the modified rosin and limit the applications in which it can be used. The disclosed methods employ at least one solvent, thus avoiding the use of a polar solvent where the ratio of polar solvent to non-polar solvent must be optimized. Advantageously, the purified modified rosin composition obtained from the disclosed methods has a higher amount of modified rosin, while the unreacted rosin is minimized. In the disclosed methods, the steps include admixing a modified rosin composition and at least one solvent to form a modified rosin solvent mixture, agitating the mixture, and isolating the purified modified rosin precipitate, for example by filtration or decantation. In any of the aspects or embodiments described herein, the methods include an additional step of heating the mixture and isolating the purified modified rosin composition from the heated mixture. In any of the aspects or embodiments described herein, when the mixture is heated, the method includes an additional step of cooling the mixture prior to the isolation step. In any of the aspects or embodiments described herein, the methods include an additional step of transferring the mixture to a continuous heated extraction apparatus and extracting with heat in the continuous heated extraction apparatus. Therefore, the disclosed methods avoid the cumbersome techniques of conventional methods. The disclosed methods relate to the preparation of isolating a purified modified rosin composition; purified modified rosin compositions prepared by the disclosed methods; and products derived from the purified modified rosin compositions.

As described above, prior methods for the purification of modified rosin compositions suffer from well-known disadvantages that prevent them from implementation, including not being scalable, not being economically feasible, having a low yield and/or purity, and/or involving waste stream management issues.

Thus, in any of the aspects or embodiments described herein, the description provides a method for purification of a modified rosin composition comprising the steps of (a) admixing a modified rosin composition and at least one solvent to form a mixture; (b) agitating the mixture; and (c) isolating a purified modified rosin composition, wherein the modified rosin composition comprises a modified rosin adduct from a cycloaddition or cationic reaction. Advantageously, the methods described herein provide purified modified rosin composition in good yield and in good purity.

In any of the aspects or embodiments described herein, the description provides a method for purification of a modified rosin composition comprising the steps of (a) adding a modified rosin composition to a continuous heated extraction apparatus, and (b) extracting the modified rosin composition with at least one solvent in the continuous heated extraction apparatus, wherein the modified rosin composition comprises a modified rosin adduct from a cycloaddition or cationic reaction.

In any of the aspects or embodiments described herein, the modified rosin composition includes a modified rosin adduct from a cycloaddition or cationic reaction of a rosin acid. Rosin acids include C20 mono-carboxylic acids with a core having a fused carbocyclic ring system comprising double bonds that vary in number and location. Examples of rosin acids include abietic acid, neoabietic acid, pimaric acid, levopimaric acid, sandaracopimaric acid, isopimaric acid, and palustric acid.

The modified rosin compositions can include Diels-Alder adducts. Diels-Alder cycloaddition can be used to form what are commonly called “rosin adducts” from rosin acids. Diels-Alder adduction occurs with s-cis conjugated double bonds, or double bonds capable achieving a conjugated s-cis configuration. For example, abietic-type rosin acids undergo Diels-Alder adduction. The modified rosin compositions can include a maleic acid adduct, a maleic anhydride adduct, a fumaric acid adduct, an acrylonitrile adduct, itaconic acid adduct, an acrylic acid adduct, or a combination thereof.

Non-limiting exemplary dienophiles that can be used to react with conjugated dienes include maleic acid, maleic anhydride, fumaric acid, acrylonitrile, itaconic anhydride, and acrylic acid. Diels-Alder products obtained from the reaction of maleic acid or maleic anhydride with a rosin acid have three carboxylic acid groups and are referred to as “maleated rosin.” Similarly, Diels-Alder products obtained from the reaction of fumaric acid with a rosin acid three carboxylic acid groups and are referred to as “fumarated rosin.”

The rosin acids can be derived from wood rosin, gum rosin, or tall oil rosin. In any of the aspects or embodiments described herein, the rosin acid is derived from crude tall oil, rosin, tall oil rosin, gum tree rosin, wood rosin, softwood rosin, hardwood rosin, distilled tall oil, derivatives thereof, or a combination thereof.

The rosin acids can include minor amounts of fatty acids in addition to the rosin acids. For example, one skilled in the art appreciates that commercial TOR also contains various levels of TOFA. In such embodiments, the carboxylic acid substrates are derived from crude tall oil, tall oil fatty acid, distilled tall oil, tall oil rosin, gum tree rosin, wood rosin, softwood rosin, hardwood rosin, a natural oil, or a combination thereof. The natural oil can include vegetable oil, safflower oil, sesame oil, canola oil, olive oil, oil, coconut oil, or a combination thereof.

The rosin acids can be substantially free of fatty acids. As used herein, “substantially free of fatty acids” means 10% or less, 5% or less, or 1% or less fatty acids, as determined by GPC or GC.

In any of the aspects or embodiments described herein, the methods include a first step of admixing a modified rosin composition and at least one solvent. The at least one solvent can include a single solvent or a mixture of two or more solvents. The at least one solvent can include a hydrocarbon solvent. The at least one hydrocarbon solvent can include a C5-C12 hydrocarbon solvent. In any of the aspects or embodiments described herein, the at least one solvent includes an aliphatic C5-C12 hydrocarbon solvent. As used herein, the term “C5-C12 aliphatic hydrocarbon solvent” refers to branched or unbranched linear hydrocarbons and branched or unbranched cyclic hydrocarbons, wherein the hydrocarbon chain can include single bonds and/or double bonds. In some aspects, aromatic hydrocarbon solvents are excluded from the C5-C12 hydrocarbon solvents. In any of the aspects or embodiments described herein, the at least one solvent includes pentane, cyclopentane, cyclopentene, hexanes, cyclohexane, cyclohexene, heptane, cycloheptane octane, cyclooctane, cyclooctene, nonane, decane, undecane, dodecane, or a combination thereof. In any of the aspects or embodiments described herein, the at least one solvent comprises at least one of hexanes, heptane, or a combination thereof.

In any of the aspects or embodiments described herein, the solvent can include a bio-based (i.e. “green”) solvent that can be used alone (and mixtures of bio-based solvents) and in combination with a hydrocarbon solvent. Such bio-based solvents can be used as alternatives to the aforementioned hydrocarbon solvents. Non-limiting examples of the bio-based solvent include an alkyl substituted cyclic ether, an alkyl cycloalkyl ether, an acetate, a lactate, a leveulinate, a terpene, or a combination thereof. The bio-based solvent can include C₃-C₁₀ alkyl substituted cyclic ether, a C₃-C₁₀ alkyl cycloalkyl ether, a C₃-C₈ acetate, a C₄-C₈ lactate a C₆-C₁₀ levulinate, or a combination thereof. The bio-based solvent can include 2-methyl tetrahydrofuran, ethyl acetate, isopropyl acetate, propyl acetate, butyl acetate, isobutyl acetate, t-butyl acetate, methyl lactate, ethyl lactate, propyl lactate, isopropyl lactate, butyl lactate, isobutyl lactate, t-butyl lactate, methyl levulinate, ethyl levulinate, propyl levulinate, isopropyl levulinate, butyl levulinate, isobutyl levulinate, t-butyl levulinate, d-limonene, α-pinene, p-cymene, or a combination thereof. The bio-based solvent can include 2-methyl tetrahydrofuran, cyclopentyl methyl ether, d-limonene, α-pinene and p-cymene, or a combination thereof.

When the bio-based solvent is used in combination with a hydrocarbon solvent, the volume ratio of the bio-based solvent to the hydrocarbon solvent can range from about 1:99 to about 99:1, about 1:95 to about 95:1, about 1:10 to about 10:1, about 1:9 to about 9:1, about 1:8 to about 8:1, about 1:7 to about 7:1, about 1:6 to about 6:1, about 1:5 to about 5:1, about 1:4 to about 4:1, about 1:3 to about 3:1, about 1:2 to about 2:1, or about 1:1.

The weight ratio of the modified rosin composition to the at least one solvent can be in any range so that the mixture of the modified rosin composition and the at least one solvent is a slurry. The weight ratio of the modified rosin composition to the at least one solvent can range from about 1:99 to about 99:1, about 1:10 to about 10:1, about 1:9 to about 9:1, about 1:8 to about 8:1, about 1:7 to about 7:1, about 1:6 to about 6:1, about 1:5 to about 5:1, about 1:4 to about 4:1, about 1:3 to about 3:1, about 1:2 to about 2:1, or about 1:1.

Preferably, the modified rosin composition to be purified is a powder. Any method known in the art can be used to prepare the powdered modified rosin composition. The non-powder form of the modified rosin composition can be crushed (dry) with a blender to form a powder.

Alternatively, the modified rosin composition be crushed as a suspension in water, filtered, and dried. Rosin can be directly crushed in a high shear mixer along with the solvent.

The modified rosin compositions can be agitated in the disclosed methods. Any agitation method known in the art can be used, for example, blending in a blender, shaking, or stirring. A system that can provide high shear is preferred.

The mixture of the modified rosin composition and the at least one solvent can be agitated with heating. For example, the mixture can be heated to a temperature below the boiling point of the solvent while vigorously stirring the mixture. Preferably, the mixture remains in slurry form during heating. The heating should be maintained at sufficient levels that would not plasticize the rosin adduct crystals or particles.

In any of the aspects or embodiments described herein, the preparation of the mixture including the modified rosin composition and the at least one solvent (i.e., admixing step) can be done at a temperature ranging from about 0° C. to about 70° C. The temperature of the mixture can range from about 0° C. to about 70° C., from about 0° C. to about 60° C., from about 0° C. to about 55° C., from about 0° C. to about 50° C., from about 0° C. to about 45° C., from about 0° C. to about 40° C., from about 0° C. to about 35° C., or from about 25° C. to about 30° C. Similarly, in the methods where a continuous extraction apparatus is used, the at least one at least one solvent is heated at about 70° C. or less, about 60° C. or less, about 55° C. or less, about 50° C. or less, about 45° C. or less, about 40° C. or less, about 35° C. or less, or from 25° C. to about 30° C. In the disclosed methods, the solvent can be removed (e.g., filtration, decantation) while hot, or alternatively, allowed to cool prior to isolating the purified modified rosin composition.

In any of the aspects or embodiments described herein, the preparation of the mixture including the modified rosin composition and the at least one solvent (i.e., admixing step) can be performed at a pressure of up to 1500 psi. Such conditions, however, depend on the type of reactor or reactors employed. The preparation of the mixture can be prepared at atmospheric pressure.

In any of the aspects or embodiments described herein, the mixture of the modified rosin composition and the solvent is agitated without heating. For example, the mixture can be agitated at ambient temperature and the mixture can then be allowed to settle. The solvent can be decanted and fresh solvent can be added to the modified rosin composition. These steps can be repeated several times to obtain the desired purity of the purified modified rosin composition.

In any of the aspects or embodiments described herein, a powdered modified rosin composition including anhydride adduct was combined with heptane. The mixture was agitated, then allowed to settle, the solvent was decanted, and fresh solvent was added. The steps were repeated at least once. The steps may be repeated 2, 3, 4, 5, or 6 times with additional washes improve purity but repeating these steps may lower the yield.

Continuous heated extraction can be used in the disclosed methods. In any of the aspects or embodiments described herein, the modified rosin composition is added to the continuous extraction apparatus with or without solvent. In any of the aspects or embodiments described herein, the mixture of the modified rosin composition and the solvent are transferred to a continuous heated extraction apparatus and extracted with heating. The continuous heated extraction apparatus enables the continuous flow of heated fresh solvent over the solid modified rosin composition. The continuous heated extraction apparatus has a percolator (boiler and reflux) which circulates the solvent, a thimble which retains the solid to be extracted, and a siphon mechanism, which periodically empties the thimble. In any of the aspects or embodiments described herein, the continuous heated extraction apparatus is a Soxhlet apparatus that can recirculate the fresh solvent by distillation. When continuous heated extraction is used, solvent use is decreased as compared with the purification methods that do not use continuous heated extraction and the solvent can be recycled.

In any of the aspects or embodiments described herein, a method includes admixing a fumaric acid rosin with at least one solvent comprising hexanes to form a mixture, agitating the mixture with heating, and isolating a purified modified rosin precipitate, wherein the fumaric acid rosin adduct composition comprises a fumaric acid rosin adduct and unreacted rosin acids.

In any of the aspects or embodiments described herein, a method includes admixing a maleic acid rosin adduct composition with at least one solvent comprising heptane to form a mixture, agitating the mixture, and isolating a purified modified rosin precipitate, wherein the maleic acid rosin adduct composition comprises a maleic acid rosin adduct and unreacted rosin acids

In any of the aspects or embodiments described herein, a powdered modified rosin composition comprising a fumarated adduct or a maleated adduct is combined with hexanes to form a mixture, and the mixture is transferred to continuous heated extraction apparatus and extracted with heating.

The disclosed methods provide purified modified rosin compositions having improved purity. In any of the aspects or embodiments described herein, the purified modified rosin compositions are at least 70% pure, 75% pure, 80% pure, 85% pure, or 90% pure, as determined by GPC and GC methods.

In any of the aspects or embodiments described herein, the description provides purified modified rosin compositions prepared according to the methods described herein. In any of the aspects or embodiments, the purified modified rosin compositions have the features as described herein.

### EXAMPLES

In the examples below, the acid number was measured by a Metrohm auto-titrator with KOH or NaOH solution by ASTM D664. The base was prepared in either methanol or distilled water. Specially, the acid number titration of the anhydride requires aqueous solutions to avoid the half ester formation.

Samples were analyzed by Waters GPC equipped with a 2707 Autosampler and 2414 Refractive Index Detector. THF was used as the mobile phase. Data acquisition and handling were made with Breeze 2 software.

Synthesis Example 1. In general, Altapyne™ Rosin R-24 and fumaric acid at proper mole ratios and with or without a catalyst were charged into a 600 mL Parr reactor. The mixture was heated to 180-220° C. for two hours. The pressure of the reactor was kept below 50 psi. The product was poured out at 180° C. Acid number, softening point and Gardner color (in toluene) were measured, in addition GPC data were collected to identify different rosin species. Maleated rosin was synthesized with similar condition by using Altapyne™ Rosin R-24 and maleic anhydride.

### Comparative Example 1: Solvent/Anti-Solvent Precipitation Method for Fumarated Rosin Purification

General Procedure for Purification of Crude product from Synthesis Example 1. This method was disclosed in WO 20200123761 as applied to the purification of rosin. The crude product from Synthesis Example 1 (45% FR, 8% MR, and 47% UR) was dissolved in a solvent selected from MeOH, toluene, IPA or propylene carbonate with gentle heating at 50° C. until the crude product had dissolved. To this solution was added an anti-solvent selected from acetonitrile. heptane, or petroleum ether to precipitate the product. The precipitate was filtered and the filter cake was air dried and then analyzed by GPC to determine the percentage of the filtered product that was fumarated rosin. The Comparative Examples and the resulting % area by GPC of the fumarated rosin are summarized in the table below.

TABLE 1
Solvent precipitation result based on GPC analysis

| | | | Ratio of | |
|---|---|---|---|---|
| Comparative | | | Antisolvent/ | FR |
| Examples | Antisolvent | Solvent | Solvent | Area % |
| 1A | ACN | MeOH | 4:1 | 19.2 |
| 1B | Heptane | Toluene | 2:1 | 39.1 |
| 1C | Heptane | Toluene | 10:1 | 72.1 |
| 1D | Pet ether | IPA | 4:1 | 42.3 |
| 1E | Heptane | Propylene | 10:1 | 47.1 |
| | | carbonate | | |

The inventors found when this method was applied to the modified rosin compositions, that the purity of the purified modified rosins was inadequate. However, when toluene was used as the solvent and heptane was used as the antisolvent and the ratio of heptane was increased, the purity of the purified modified rosin was substantially improved (compare Comparative Example 1C with Comparative Example 1B).

### Comparative Example 2: Biphasic Extraction Method for Fumarated Rosin Purification

This approach was the method described in U.S. Pat. No. 3,562,243, where a polar liquid solvent and a non-polar organic liquid solvent were used that were immiscible with each other. However, as acknowledged in U.S. Pat. No. 3,562,243, in order for the two solvents to be immiscible, water had to be added to the polar solvent. In addition to following the patent example from U.S. Pat. No. 3,562,243, where methanol and water were the polar solvent and heptane as the nonpolar solvent, other polar solvents such as acetic acid, IPA, acetone and propylene carbonate were tested that provided unsatisfactory results (results not shown).

Purification Procedure and Results. 450 g of fumarated crude product from Synthesis Example 1, 400 g methanol, 250 g water and 400 g heptane were mixed to dissolve the crude product. The two layers were allowed to separate. The layers were separated and each layer was concentrated to remove the solvent. After removal of the polar solvent, 195 g of off-white solid was obtained with 85% purity by GPC analysis while the non-polar portion yielded 240 g unreacted rosin with 75% purity by GPC.

Example 1A. Single solvent precipitation to obtain fumarated rosin. Herein, 250 g of fumarated rosin product from Synthesis Example 1 was crushed dry with a blender into powder (alternatively, it can be crushed with 200 g water and followed by filtration to collect air dried powder) and mixed with 450 g hexanes and heated to 50° C. for 1 hr. Then, the precipitate was filtered to collect an off-white solid (140 g) and according to GPC analysis, the precipitated solid was 75% pure by GPC with the remaining 21% unreacted rosin and 4.5% maleated rosin. The softening point was >150° C. and acid number was 327 mg KOH/g. A similar process was carried out by crushing fumarated rosin from Example 1 in heptane at 2:1 ratio in a high shear blender. This was repeated 3-5 times at 1:1 sample to solvent ratio. The final product was a white powder that was air dried. Additional vacuum oven drying was done at 90° C. and <10 torr. The pure adduct yields were 30-45%. The acid number (aqueous) was 320.5 mg KOH/g and softening point was 166.4° C. The GPC purity was >85%.

Example 1B. Single solvent precipitation for maleated rosin purification. Maleated rosin 1500 g was prepared by the reaction of Altapyne™ Rosin R-24 with maleic anhydride (14 wt %) at 180° C. for 3 h. The reaction mixture was cooled to room temperature and crushed in a high shear blender with heptane at 1:2 weight ratio. The mixture was allowed to settle, and the solvent was decanted or filtered off. The precipitated product was diluted with fresh heptane and stirred rapidly again. This was repeated 3-5 times at 1:1 sample to solvent weight ratio. The filter cake was dried in a vacuum oven at 80-120° C. The product was isolated as an off-white powder with the pure adduct yield 25-40%. Sample analysis indicated an acid number (aqueous) 383.5 mg KOH/g and softening point 133.8° C. The GPC purity was >88%.

Example 1C. General Procedure for Soxhlet extraction purification. To a stirring solution of hexane 500 mL was added 100 g of the ground powder of the crude product from a cycloaddition reaction with fumaric acid or the crude product from a cycloaddition reaction with maleic anhydride. Then the slurry was transferred directly into a Soxhlet thimble (43 mm×123 mm) and extracted with ˜500 mL hexane in a 1 L flask for 8 h and about 120 cycles. Samples were taken at 3 h, 4 h, and 8 h for analysis. Products were recovered, dried in air, and vacuum oven dried at 80° C.

Isolated Fumarated Rosin. 38 g of purified product was isolated from the Soxhlet purification of the crude product from the cycloaddition reaction of fumaric acid with rosin. The softening point was 170.6° C., the DSC transition temperature was 124.3° C., and the GPC purity was >82%.

Isolated Maleated Rosin 46 g of purified product was isolated from the Soxhlet purification of the crude product from the cycloaddition reaction of maleic acid with rosin. The softening point was 139.7° C., the DSC transition temperature was 107.7° C., and the GPC purity was >82%.

TABLE 2
Acid numbers of the Soxhlet extracted Diels-Alder rosin products.
Aqueous acid was used to measure the acid number to make sure the
anhydride fully reacts with the base without forming half esters.

| Sample | Extracted hours | Acid number (mg KOH/g) |
|---|---|---|
| Fumarated | 0 | 267.7 |
| rosin | 3 | 308.9 |
| | 4 | 313.7 |
| | 8 | 341.0 |
| | 8 | 329.7 (methanolic) |
| Maleated | 0 | 236.9 |
| rosin | 3 | 242.2 |
| | 4 | 284.5 |
| | 8 | 347.8 |
| | 8 | 296.8 (methanolic) |

While several embodiments of the invention have been shown and described herein, it will be understood that such embodiments are provided by way of example only. Numerous variations, changes and substitutions will occur to those skilled in the art without departing from the spirit of the invention. Rather, the present disclosure is to cover all modifications, equivalents, and alternatives falling within the scope of the present disclosure as defined by the following appended claims and their legal equivalents. Accordingly, it is intended that the description and appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients can be varied to optimize the desired effects, additional ingredients can be added, and/or similar ingredients can be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

1. A method for purification of a modified rosin, the method comprising
a. admixing a modified rosin composition and at least one solvent to form a mixture;
b. agitating the mixture; and
c. isolating a purified modified rosin precipitate,
wherein the modified rosin composition comprises a modified rosin including an adduct from a cycloaddition or cationic reaction.

2. The method of claim 1, wherein the modified rosin composition further comprises a rosin acid that did not undergo the cycloaddition or cationic reaction.

3. The method of claim 1, wherein the modified rosin comprises a maleic acid adduct, maleic anhydride adduct, a fumaric acid adduct, an acrylonitrile adduct, itaconic acid adduct, itaconic anhydride adduct, an acrylic acid adduct, or a combination thereof.

4. The method of claim 1, wherein (b) agitating the mixture is performed with heating.

5. The method of claim 1, further comprising, after (b) agitating the mixture, transferring the mixture to a continuous heated extraction apparatus and extracting the mixture with heat in the continuous heated extraction apparatus.

6. The method of claim 1, wherein a ratio of the weight of the modified rosin composition to the solvent is about 1:10 to about 10:1.

7. The method of claim 1, wherein the solvent comprises at least one hydrocarbon solvent, a bio-based solvent, or a combination thereof.

8. The method of claim 1, wherein the solvent comprises at least one C₅-C₁₂ aliphatic hydrocarbon solvent.

9. The method of claim 1, wherein the solvent comprises at least one of pentane, cyclopentane, cyclopentene, hexane, cyclohexane, cyclohexene, heptane, cycloheptane, octane, cyclooctane, cyclooctene, nonane, decane, undecane, decane, dodecane, or a combination thereof.

10. The method of claim 1, wherein the solvent comprises at least one of an alkyl substituted cyclic ether, an alkyl cycloalkyl ether, an acetate, a lactate, a leveulinate, a terpene, or a combination thereof.

11. The method of claim 1, wherein the solvent comprises a C₃-C₁₀ alkyl substituted cyclic ether, a C₄-C₁₀ alkyl cycloalkyl ether, a C₃-C₈ acetate, a C₄-C₈ lactate, a C₆-C₁₀ levulinate, or a combination thereof.

12. The method of claim 1, wherein the solvent comprises 2-methyl tetrahydrofuran, ethyl acetate, isopropyl acetate, propyl acetate, butyl acetate, isobutyl acetate, t-butyl acetate, methyl lactate, ethyl lactate, propyl lactate, isopropyl lactate, butyl lactate, isobutyl lactate, t-butyl lactate, methyl levulinate, ethyl levulinate, propyl levulinate, isopropyl levulinate, butyl levulinate, isobutyl levulinate, t-butyl levulinate, d-limonene, α-pinene, p-cymene, or a combination thereof.

13. The method of claim 1, wherein the solvent comprises 2-methyl tetrahydrofuran, cyclopentyl methyl ether, d-limonene, α-pinene and p-cymene, or a combination thereof.

14. The method of claim 1, wherein the modified rosin of the modified rosin composition is derived from at least one gum rosin acid, wood rosin acid, tall oil rosin acid, or a combination thereof.

15. The method of claim 1, wherein (a) admixing, (b) agitating, and (c) isolating are repeated at least once.

16. The method of claim 5, wherein the continuous heated extraction apparatus comprises a Soxhlet-type apparatus.

17. The method of claim 15, wherein the purified modified rosin precipitate comprises 70% or greater of a maleic acid adduct, maleic anhydride adduct, a fumaric acid adduct, an acrylonitrile adduct, itaconic acid adduct, itaconic anhydride adduct, an acrylic acid adduct, or a combination thereof, as determined by gel permeation chromatography.

18. The method of claim 1, wherein the method comprises:
a. admixing a fumaric acid rosin adduct composition and at least one solvent comprising a hexanes to form a mixture;
b. agitating the mixture with heating; and
c. isolating a purified modified rosin precipitate,
wherein the fumaric acid rosin adduct composition comprises a fumaric acid rosin adduct and a rosin acid that did not undergo the cycloaddition or cationic reaction.

19. The method of claim 1, wherein the method comprises:
a. admixing a maleic acid rosin adduct composition and at least one solvent comprising a heptane to form a mixture;
b. agitating the mixture;
c. isolating a purified modified rosin precipitate,
wherein the maleic acid rosin adduct composition comprises a maleic acid rosin adduct and a rosin acid that did not undergo the cycloaddition or cationic reaction.

20. A method for purification of a modified rosin, the method comprising
a. adding a modified rosin composition to a continuous heated extraction apparatus; and
b. extracting the modified rosin composition with at least one solvent comprising a hexanes in the continuous heated extraction apparatus;
wherein the modified rosin composition comprises a modified rosin comprising an adduct from a cycloaddition or cationic reaction.

21. The method of claim 20, wherein the continuous heated extraction apparatus comprises a Soxhlet-type apparatus.

22. The method of claim 20, wherein the modified rosin comprises a maleic acid adduct, a maleic anhydride adduct, a fumaric acid adduct, an acrylonitrile adduct, itaconic acid adduct, itaconic anhydride adduct, an acrylic acid adduct, or a combination thereof.

23. The method of claim 20, wherein the solvent comprises at least one C₅-C₁₂ hydrocarbon solvent.

24. An article comprising the modified rosin precipitate of claim 1.

25. An article comprising the modified rosin precipitate of claim 1.
